(19) United States
(12) Patent Application Publication
(10) Pub. No.: US 2009/0178731 A1
(43) Pub. Date: Jul. 16, 2009

(54) Rehabilitation of discarded wooden railroad ties having disabling cracks in the ends of the ties

(76) Inventor: David Ollendick, Ogden, UT (US)

Correspondence Address: Lynn G. Foster, 65 N Street, Suite C3, Salt Lake City, UT, 84103, US

(21) Appl. No.: 12/381,109

(22) Filed: Mar. 6, 2009

Related U.S. Application Data
(63) Continuation-in-part of application No. 11/471,317, filed on Jun. 20, 2006.

(51) Int. Cl. B27M 3/14

(52) U.S. Cl. 144/330

(57) ABSTRACT

Apparatus and methodology are disclosed pertaining to selecting from a stockpile of used and discarded ties those which can be restored for a second use, removing accumulated scale from the selected used ties, redimensioning the selected ties to a usable smaller size, filling and sealing tie end cracks with a suitable filler, transversely compressing the ties to substantially close the adhesive-filled cracks, applying a permanent fastener to retain the compressed state of the closed and sealed tie cracks and externally treating the fastened ties with pesticide and anti-rotting composition or compositions.

### CONTINUITY

This Application is a continuation-in-part of co-pending U.S. patent application Ser. No. 11/471,317, filed Jun. 20, 2006.

### FIELD OF INVENTION

This invention relates generally to railroad ties and more specifically to methodology and apparatus for rehabilitating wooden railroad ties, in salvage condition, having one or more disabling cracks in one or both ends of each tie.

### BACKGROUND

Hundreds of thousands if not millions of spent and discarded wooden railroad ties clutter the American Continent and other locations as well. A principal cause of such railroad ties no longer being serviceable is due to disabling end cracks in the ties. After being discarded, the disabled wooden ties have only nominal value for constructing pig pens, supports for landscaping, fence posts and conversion to sawdust for compost, filler material or fuel. If used for fuel, either in solid or saw dust form, environmental pollution becomes a concern because the tie is typically impregnated with Creosote.

Discarded split or cracked wooden railroad ties has been a long term problem and, heretofore, no way has been found to effectively and cost efficiently reclaim or rehabilitate these ties for a later second use to support the rails of a railroad.

An additional problem in supplying ties to railroads resides in the very high cost of new ties, including harvesting timber, cutting and processing ties from the timber, curing the ties, treating the ties with Creosote or the like for maximum longevity, storing and transporting of the finished tie to an installation site. If spent, discarded ties or some of them can be rehabilitated, the cost, when compared to new ties, will be much lower and the number of trees harvested for railroad tie purposes greatly reduced.

Durrenberger (U.S. Pat. No. 2,956,498) proposes a complex machine for expensively binding wooden railroad ties to cure or prevent cracking. No size or dimension modification occurs. A chain is wrapped around three sides of the tie while the tie is independently suspended in the air between a narrow stop and a clamping head activated by a pneumatic cylinder under manual control. The chain is positioned in a U-shaped configuration in spaced relation around three sides of this tie in offset relation to the opposed tie engagement site of the stop and the clamping head. A metal band leaving two free ends is wrapped around four sides of the tie in the alignment with the spaced chain. Two pneumatic cylinders, associated with the chain, are manually actuated to cause the chain to apply force to the three sides of the tie and three sides of the metal band, while the tie is suspended in the air. The overlapping free ends of the metal band above the tie are welded to each other. No removal of weather-related scale from used ties is contemplated by Durrenberger, so the band will loosen when the scale flakes off later during use under railroad rails.

No crack filler or sealant, is used, nor is the tie treated to prevent rot and attack by insects.

### BRIEF SUMMARY AND OBJECTS OF THE INVENTION

In brief summary, the present invention overcomes and/or alleviates problems of the past concerning end split discarded wooden railroad ties. Apparatus and methodology of this invention accommodate selecting from a stockpile of used and discarded ties those which can be restored for a second use, removing accumulated scale from the selected used ties, sizing the selected ties to a usable length and depth, filling and sealing the voids including cracks at either or both ends of the selected used ties with a suitable adhesive filler, transversely compressing the sealed and descaled ties to substantially close the adhesive-filled cracks, applying a permanent fastener to retain the compressed state of the closed and sealed tie cracks and externally treating the fastened ties with pesticide and anti-rotting composition or compositions. Thus, the present invention repairs, reclaims and rehabilitates used and discarded end cracked wooden railroad ties so as to close the end cracks for subsequent long term use to support rails of a railroad.

It is a primary object of this invention to overcome and/or alleviate problems of the past concerning end split or cracked discarded wooden railroad ties.

It is another significant object to provide apparatus and methodology for repairing, reclaiming and rehabilitating discarded used end cracked wooden railroad ties so as to close the end cracks for subsequent long term use to support rails of a railroad.

Another paramount object is to reclaim discarded or spent wooden railroad ties by selecting those which can be restored to used, redimensioning the length and depth of the selected ties, removing scale from the selected spent ties, adhesively filling and sealing voids including end cracks in the selected ties, compressing the ties to close the adhesively filled end cracks, applying permanent end fasteners to retain the compressed state and externally treating the ties to prevent deterioration due to insects and rotting.

Another principal object is to reduce the cost of supplying ties for railroad track repairs and new construction of railroad tracks.

Another important object is to lower the number of trees which must be harvested for railroad tie purposes.

An object of significance is reducing or eliminating unsightly stockpiles of discarded used wooden railroad ties.

These and other objects and features of the present invention will be apparent from the detailed description taken with reference to the accompanying drawings.

### BRIEF DESCRIPTION OF THE DRAWINGS

FIG. 1 is a fragmentary perspective of a split end of a reclaimable discarded or salvage used wooden railroad tie being filled and sealed with an adhesive composition;

FIG. 2 is a diagrammatic perspective of an apparatus by which force or compression temporarily closes filled and sealed cracks in one or both ends of a discarded or salvage used wooden railroad tie and over which end cap retainers are installed to hold the compressed tie ends permanently closed after the compression force is removed;

FIG. 3 is a schematic top view of a system, similar to FIG. 2, using hydraulic and/or pneumatic cylinders to permanently close the filled and sealed end cracks or splits in a used wooden railroad tie;

FIG. 4 is a perspective of a rehabilitated previously discarded split end wooden railroad tie with end caps, ready for reuse to support the rails of a railroad;

FIG. 5 is a fragmentary cross section of one split end of a rehabilitated previously used wooden railroad tie, where the filled and sealed cracks are held permanently closed by a spiked clete;

FIG. 6 is a fragmentary cross section of one split end of a used rehabilitated wooden tie, where the filled and sealed end cracks are held permanently closed by a tight circumferential band; and

FIG. 7 is a flow chart depicting in detail the acts used in practicing the present invention to rehabilitate discarded used railroad ties for reuse to support the rails of a railroad.

### DETAILED DESCRIPTION OF THE ILLUSTRATED EMBODIMENTS

In the past, there has been no cost effective and reliable railroad technology but which used discarded and disabled previously used wooden railroad ties with split ends could be reclaimed, refurbished or rehabilitated for subsequent use to support the rails of a railroad track. Because it is commonplace for wooden ties to significantly split at one or both ends during use and, as a result, be discarded, there are hundreds of thousands if not millions of these type of used and discarded wooden railroad ties across this continent and in other places. Some of these discarded wooden railroad ties are left as ugly accumulations at various salvage locations. Others are used to construct pig pens, to do terraced landscaping, as fence posts and others are converted to sawdust for compost or used as filler material or fuel. Use as fuel is restricted, however, because typically wooden railroad ties are treated with Creosote, which, when burned, produces undesired and perhaps prohibited air pollution.

The present invention consists of apparatus and methodology by which used and discarded end cracked wooden railroad ties are repaired, reclaimed and rehabilitated so as to close and seal the end cracks on a permanent basis for subsequent long-term use to support spaced rails of a railroad track. From a stockpile of used and discarded railroad ties with at least one split end, those which can be reclaimed for a second use, employing the present invention, are visually selected for processing. The selected used ties are subject to scale removal, by, for example, using large commercially available surface planers, although other equipment could be used. Scale comprises an external coating on the tie caused by exposure to the atmosphere including weather, which, if not removed during the tie reclaiming process, will later flake off, reducing the circumferential dimensions and causing any retainer at the tie ends to loosen.

Either before or after scale removal, each selected used tie is resized dimensionally which comprises cutting the tie to a new length consistent with any damage earlier caused to the tie and the need for ties having lengths of 9 feet, 8½ feet, 8 feet and 6 feet, for example, and eliminating plate cuts, which reduces the depth of the ties.

A suitable commercially-available adhesive base filler material is placed, by extrusion or otherwise, in the end cracks and other tie voids to fill and seal the cracks and voids to prevent infiltration of water and other deleterious material and to preserve the structural integrity of the wood of which the ties are composed. The filler material preferably comprises polyurethane and an adhesive.

Compression is imposed on opposed sides of the tie across one or both ends of the railroad tie or to the entirety of the filled and sealed tie to squeeze the filled and sealed end cracks substantially closed. Any filler material flowing from any closed crack can be scraped or wiped off prior to curing of the filler material. While held in the crack-closing compressed condition, a retainer is applied to prevent the tie end from spreading to thereby permanently hold the cracks in the closed condition, after which the opposed compression forces are removed. A commercially available hydraulic or pneumatic press may be used to apply the compression. The retainer, thereafter, holds cracks at the ends of each tie permanently in a closed condition and the reclaimed ties are thereafter used to support the rails of a railroad track. The opposed compressive forces applied to the ties are in a transverse direction and may utilize a stop contiguous with one side of the tie end and a hydraulic or pneumatic cylinder at the other side. The retainer, permanently holding the cracks closed, may comprise a cup-shaped end cap, an end clete, a circumferential band or any other suitable type of retainer by which the cracks at the ends of the ties are retained in a closed condition. The retainers may be applied using power-driven applicators.

To prevent deterioration and rotting due to insects and other causes the external surface of the complete previously used ties are preferably coated and/or impregnated with commercially available pesticide and anti-rotting compositions.

Reclaimed ties per the present invention reduce the cost of tie production because the discarded ties are owned by the railroad. The present invention significantly reduces the number of trees which must be harvested to meet ongoing demand for wooden railroad ties. It also alleviates or eliminates unsightly stockpiles of discarded used railroad ties and related ground contamination caused by weather-leaching of Creosote or the like from the ties into the soil.

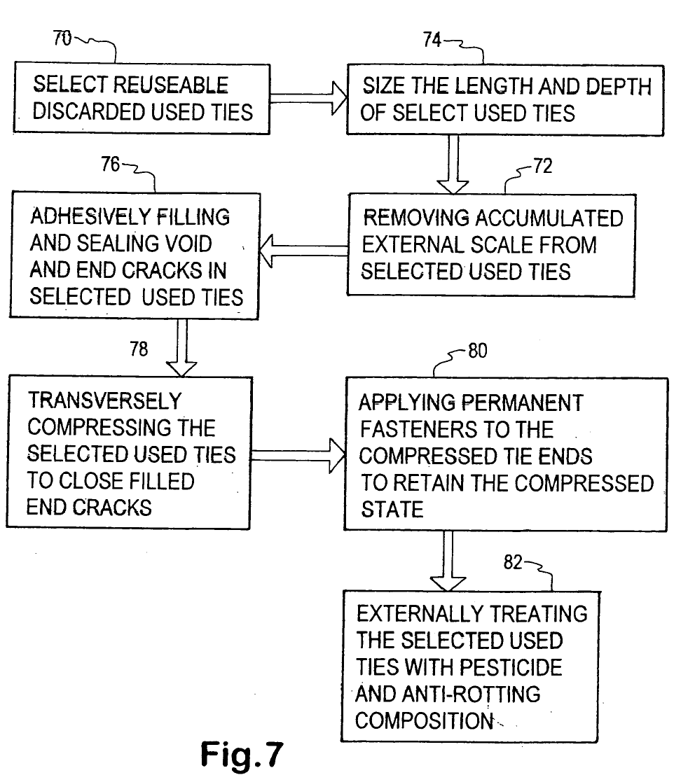

Reference is now made to the drawings wherein like numerals are used to designate like parts throughout. FIG. 7 comprises a flow chart or diagram of the detailed methodology of the present invention. Used and discarded end cracked wooden railroad ties are repaired, reclaimed and rehabilitated using the present invention so as to close and seal the end cracks on a permanent basis for subsequent long-term use to support spaced rails of a railroad track.

The sequence of the acts depicted in FIG. 7 may be determined by those skilled in the art. From a stockpile 70 of used and discarded railroad ties with at least one split end, those which can be reclaimed for a second use, employing the present invention, are visually selected and segregated for processing. The selected used ties are subject to scale removal at location 72, preferably using one or more large commercially-available surface planers, although other equipment could be used. Scale comprises an external coating on the ties caused by exposure to the environment including weather, which, if not removed during the tie reclaiming process will flake off reducing the circumferential dimensions and causing loosening of retainers at or near the tie ends.

Either before of after scale removal, each selected used tie is cut to a length at location 74 consistent with any tie damage and the need for ties having lengths of 9 feet, 8½ feet, 8 feet and 6 feet, for example.

Railroad ties of a track, each have two railroad plates which rest upon the top surface of the tie and which supports the rails and the weight of the trains displaced across the rails. Over time, the top of the ties become indented by the plates, a condition called plate cuts. The present invention contemplates using commercially-available equipment to shave the material from the top surface of the ties being reclaimed for a second use ample to eliminate the plate cuts. Shaving of about 1 inch off the top is typically about the right amount. When this is done the earlier cross sectional dimension of a depth of 7 inches and a width of 9 inches becomes 6 inches by 9 inches, respectively.

A suitable commercially-available adhesive base filler material is placed, by extrusion or otherwise, in the end cracks and other tie voids at location 76 to fill and seal the same to prevent infiltration of water and other deleterious material and to preserve the structural integrity of the wood of which the ties are composed. While those skilled in the art may select the filler material best suited to be used for different woods and different weather conditions, it is currently preferred to use water resistant polyurethane mixed with adhesive.

Compression is applied at site 78 to one or both ends of the railroad tie or to the entirety of the filled and seated tie to squeeze the filled and sealed end cracks substantially closed. Any filler material flowing from any closed crack can be scraped or wiped off. While held in the crack-closing compressed condition, a retainer or fastener is applied to one or both tie ends at site 80 to prevent the ends from spreading to thereby permanently hold the crack or cracks in the closed condition, after which the compression force is removed. A commercially available hydraulic or pneumatic press may be used to apply the compression. Each retainer or fastener, thereafter, holds the crack or cracks at the end or ends of the tie permanently in a closed condition, at all times including when the reclaimed ties are used to support the rails of a railroad track. The compressive force applied to the ties is preferably across the two sides of the ties in a transverse direction and may involve use of a stop on one side of the tie end and a hydraulic or pneumatic cylinder on the other side. The retainer permanently holding the cracks closed may comprise a cup-shaped end cap, an end clete, a circumferential band or any other suitable type of retainer by which the cracks at the end of the ties are retained in a closed condition. The retainers may be applied using power-driven applicators.

To prevent deterioration and rotting due to insects and other causes the external surface of the completed previously used ties are preferably coated and/or impregnated with commercially-available pesticide, such as Cu-Rap, and anti-rotting compositions at location 82. Twenty Mule Team Borax may be used as both a pesticide and an anti-rotting substance.

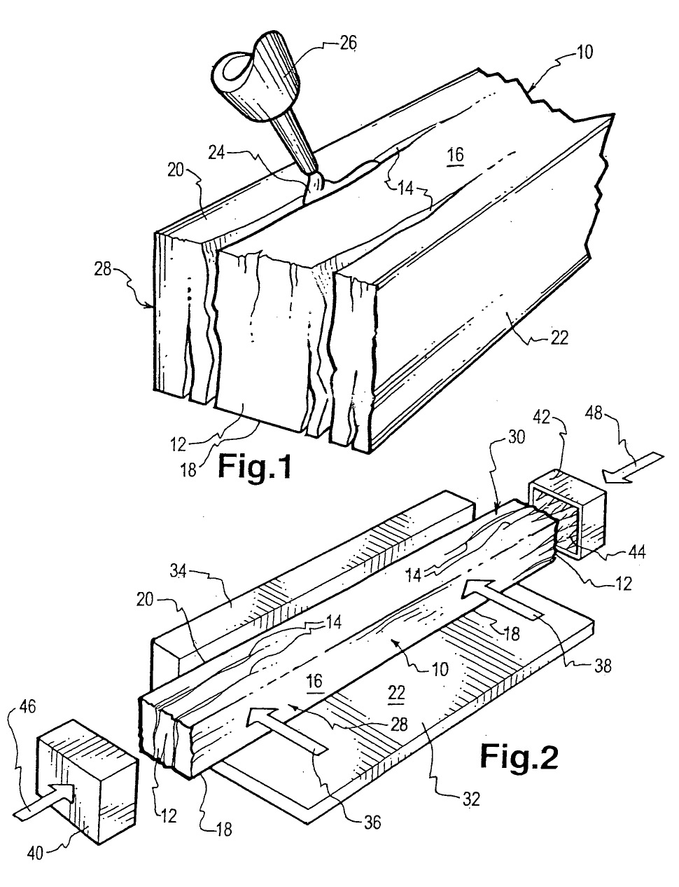

FIG. 1 illustrates in fragmentary perspective a used and discarded railroad tie generally designated 10. The discarded tie, identified as tie 10, may have a single generally vertical end crack, which often runs from the blunt end surface 12 to a location adjacent to a tie plate upon which a railroad rail rests, prior to the tie being removed and discarded. Sometimes one or both ends of the tie have multiple disabling cracks. Two such typical cracks 14 are illustrated in FIG. 1. Cracks 14 are illustrated as extending a substantial distance in a longitudinal direction, with each crack or slit 14 may span between the top surface 16 the bottom surface 18 of the tie. The tie 10 also comprises opposed side surfaces 20 and 22.

After the selecting, sizing and scale removal acts described above in conjunction with FIG. 7, commercially-available polymer based adhesive filler material is deposited in the cracks 14. This placement may be done in any suitable way, including, but not limited to, use of an extrusion gun 26 (FIG. 1.)

FIG. 2 illustrates in diagrammatic perspective the tie compression act. Tie 10, having filled and sealed cracks 14 at both ends 28 and 30 is placed upon a rigid support of platform 32 so that the bottom surface 18 of the tie rests upon the top surface of the support platform 32, with the top surface 16 exposed to view and the tie ends extend beyond the stop 34 and the platform 32. Side 20 is contiguous with a rigid stop 34 while force is applied to the side 22 at ends 28 and 30 in the direction of side 20. This is shown diagrammatically at 36 and 38 so as to oppositely compressively close the filled and sealed cracks 14 at each end and to temporarily hold these cracks closed as cup-shaped end caps 40 and 42 are forcibly applied longitudinally to each closed end 28 and 30 to thereby permanently retain the cracks in a closed condition. The end caps 40 and 42 are illustrated as containing exposed spikes 44 with each cup which spikes penetrate the ends 14 of the tie when the end caps 40 and 42 are subjected to the forces diagrammatically illustrated at 46 and 48, respectively.

Once the end caps 40 and 42 have been properly placed over and securely attached to the ends 12 of the tie so as to be secure against inadvertent removal, the tie is fully reconditioned and rehabilitated as illustrated in FIG. 4. At this point, crack closing forces 36 and 38 are removed as are forces 46 and 48. The completed rehabilitated tie, illustrated in FIG. 4, can be stored on site, placed in a warehouse or at an outdoor storage site or taken immediately for installation under railroad rails of a railroad track being repaired or constructed.

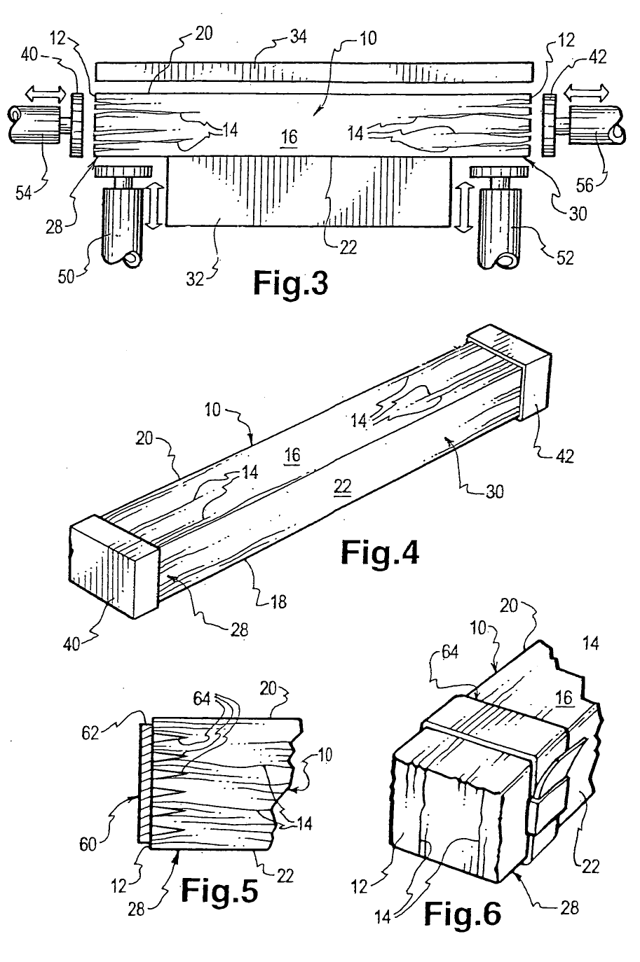

It is the intention, in further reference to FIG. 2, that the manner in which forces 36, 38, 46 and 48 are applied may be as a result of any suitable method or means. In reference to FIG. 3, one suitable approach is to apply force 36 utilizing the two-way hydraulic or pneumatic cylinder 50, to apply force 38 utilizing a two-way hydraulic or pneumatic cylinder 52, to apply force 46 utilizing a two-way cylinder 54 and to apply force 48 utilizing a two-way cylinder 56. However, as mentioned above, any suitable force-applying technique may be used to carry out the methodology of FIG. 2.

In lieu of end cap retainers 40 and 42, a clete, generally designated 60 may be utilized at one or both ends when the tie is transversely under compression. See FIG. 5. Clete 60 is illustrated as comprising an exposed plate with spikes extending from the plate 62 so as to be substantially embedded in the material comprising the tie 10 at the end thereof thereby permanently holding the cracks 14 in their closed condition.

In lieu of retainers 40, 42 and 60, a steel band 64 may be utilized, which is placed around the free ends of the tie and tightened when the tie is transversely under compression to compressively hold an end of the tie so as to retain the cracks closed may be utilized. See FIG. 6. Any type of packaging-type steel band may be applied to the cracked end of the tie, using commercially-available band applicators.

The invention may be embodied in other specific forms without departing from the spirit or essential characteristics thereof. The present embodiments are, therefore, to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A used rehabitated wooden railroad tie selected and reprocessed from a stockpiling of discarded used wooden ties comprising:
at least one substantially closed end crack in the tie containing a water resistant filler material;
a retainer contiguous with the tie and adjacent to the end crack holding the end crack in its substantially closed state;
a severed tie end reducing the length of the tie to less than its original length but useable to support railroad rails;
a tie top free of tie plate cut earlier existing in the discarded tie.

2. A method for reclaiming used discarded wooden railroad ties for further use to support rails of a railroad track comprising the acts of:
selecting from a source of used discarded wooden railroad ties, each having one or more end cracks, those ties which can be restored for a second use;
redimensioning each selected tie to reduce the length and the depth of the selected ties;
removing scale from the selected ties;
filling and sealing end cracks in the selected ties;
compressing the ties to substantially close the filled end cracks;
applying permanent end retainers to the ties to retain the ties in the compressed state; and
externally treating the ties to prevent deterioration due to insects and rotting.

3. A method rehabitating for a second use previously used and discarded wooden railroad tie comprising the acts of:
selecting from a stockpile of used and discarded ties those which can be restored for a second use;
removing accumulated scale from the selected used ties;
down sizing the selected ties to a usable reduced length and depth;
filling and sealing cracks at either or both ends of the selected used ties with an adhesive water resistant filler;
transversely compressing the sealed and descaled ties to substantially close the adhesive-filled cracks;
applying one or more permanent fasteners to retain the compressed state of the closed and sealed tie cracks; and
externally treating the fastened ties with one or more pesticides and anti-rotting compositions.

4. A used discarded but rehabitated wooden railroad tie comprising:
at least one substantially closed end crack in the tie sealed by a filler material;
a retainer contiguous with the tie and adjacent to the filled end crack holding the end crack in its substantially closed state;
the size of the tie being reduced to less than its original size but useable to support railroad rails.

5. A method for reclaiming used discarded wooden railroad ties for further use to again support rails of a railroad track comprising the acts of:
selecting from a source of used discarded wooden railroad ties, each having one or more end cracks, those ties which can be restored for a second use;
redimensioning each selected tie to reduce its size;
removing scale from the selected ties;
filling and sealing end cracks in the selected ties;
compressing the ties to substantially close the filled end cracks; and
applying permanent end retainers to the ties to retain the ties in their compressed state.

6. A method of rehabitating for a second use a previously used and discarded wooden railroad tie comprising the acts of:
selecting a used and discarded tie to be restored for a second use;
removing accumulated scale from the selected used tie;
reducing the size of the selected tie;
sealing cracks at either or both ends of the selected used tie with a filler material;
transversely compressing the sealed and descaled tie to substantially close the sealed cracks; and
applying one or more permanent fasteners to retain the compressed state of the closed and sealed tie cracks.
